(19) United States
(12) Patent Application Publication
(10) Pub. No.: US 2002/0029453 A1
(43) Pub. Date: Mar. 14, 2002

(54) Apparatus and process for producing high quality metallic fiber tow

(76) Inventors: Nathaniel R. Quick, Lake Mary, FL (US); Michael Liberman, Deland, FL (US); Raymond R. McNeice, Debary, FL (US)

Correspondence Address: Robert F. Frijouf, Frijouf, Rust & Pyle, P.A., 201 East Davis Boulevard, Tampa, FL, 33606, US

(21) Appl. No.: 09/950,446

(22) Filed: Sep. 10, 2001

Related U.S. Application Data
(60) Provisional application No. 60/231,643, filed on Sep. 11, 2000.

(51) Int. Cl. B23P 17/00; B21F 1/06

(52) U.S. Cl. 29/423; 29/33 F; 140/104

(57) ABSTRACT

An apparatus and process is disclosed for making fine metallic fiber tow comprising the steps of cladding an array of metallic wires with an array cladding material to provide an array cladding. The array cladding is drawn for reducing the diameter thereof and for reducing the corresponding diameters of each of the metallic wires of the array within the array cladding for producing an array of fine metallic fibers. A series of bends is formed in the array cladding. The array cladding is placed onto a support with the series of bends creating spaces between adjacent portions of the array cladding to minimize the number of direct contacts between adjacent portions of the array cladding. The array cladding material is removed for producing metallic fiber tow. The apparatus of the present invention forms the bends in the array cladding.

### CROSS-REFERENCE TO RELATED APPLICATIONS

This application claims benefit of United States Patent Provisional application Serial No. 60/231,643 filed Sep. 11, 2000. All subject matter set forth in provisional application Serial No. 60/231,643 is hereby incorporated by reference into the present application as if fully set forth herein.

### BACKGROUND OF THE INVENTION

1. Field of the Invention

This invention relates to metallic tow or metallic cord and more particularly to an apparatus and method of producing high quality metallic fiber tow.

2. Description of the Related Art

This invention relates to metallic fiber tow or metallic fiber cord and more particularly to an improved apparatus and method of producing high quality metallic fiber tow having a fiber tow. Metallic fiber tow is generally characterized as an array of parallel metallic fibers forming a continuous cord of suitable length. Typically, each of the metallic fibers of the fiber tow is less than 50 microns in diameter. The metallic fiber tow normally includes continuous metallic fibers and a quantity greater than 500 parallel metallic fibers.

The production of high quality metallic fiber tow is a more difficult task than the production of high quality chopped metallic fibers. Typically, metallic fibers have a length of less than 2 to 3 centimeters. Both the metallic tow and the metallic chopped fibers are formed in a similar manner. The fibers are formed by cladding an array of metallic wires and drawing the cladding to reduce the outer diameter thereof and the corresponding diameters of the array of metallic wires thereby producing an array of metallic fibers. The chopped metallic fibers are produced by chopping the cladding into sections of less than two to three centimeters and leaching the chopped fibers into a leaching bath to remove the cladding material. The chopped portions of the cladding are randomly placed in a leaching basket and are leached to remove the cladding material thereby producing randomly oriented chopped metallic fibers.

The metallic fiber tow is made in a similar fashion with the exception that the continuous cladding of continuous metallic fibers must be leached as a continuous cord. The prior art has utilized two methods of leaching the continuous cord, namely the continuous leaching process and the batch leaching process. In the continuous leaching process, the continuous cladding containing the array of metallic fibers is pasted through a longitudinally extending leaching bath thereby giving the chemical agent sufficient time to remove the cladding material leaving the array to produce metallic fiber tow. This process necessitated the use of a long leaching bath, which was unsatisfactory in many cases. Secondly, the continuous cladding material had to be pulled through the longitudinally extending leaching tank thereby placing substantial stress on the metallic fibers after removal of the cladding material. This stress caused breakage in some of the metallic fibers in the metallic fiber tow thereby reducing the quality of the metallic fiber tow. A second method of leaching the continuous metallic material was through a batch process. In the batch process, the continuous cladding material was reeled onto a leaching spool and placed in a leaching bath. In order to prevent the metallic fibers from being entangled with adjacent metallic fibers, the cladding material was twisted as the cladding material was reeled onto the leaching spool. After the batch leaching process, the metallic fiber tow had to be removed from the leaching spool for placing on a transport spool or for ultimate use. Unfortunately, the twisting of the cladding and the untwisting of the fiber tow did not totally prevent the fiber tow from being entangled with adjacent fibers of an adjacent portion of the fiber tow. In addition, the twisting and untwisting resulted in breakage of fibers thereby providing poor quality metallic fiber tow.

Many in the prior art have attempted to provide a solution for the manufacturing and production of high quality metallic fiber tow. Among the prior art that have attempted to provide a solution for the manufacturing and production of high quality metallic fiber tow are the following United States Patents.

U.S. Pat. No. 2,050,298 to Everett discloses a process for the production of stranded wire by reduction from elements of comparatively large cross-sections. It comprises the steps of assembling of a plurality of said elements in side-by-side relationship. It is encasing the assembly of elements, reducing the bundle thus formed as a unit, imparting a permanent helical twist to the reduced bundle and then removing the casing.

U.S. Pat. No. 3,505,039 to Roberts et al. discloses a product defined as fine metal filaments, such as filaments of under approximately 15 microns diameter, in long lengths wherein a plurality of sheathed elements are first constricted to form a reduced diameter billet by means of hot forming. After the hot forming constriction, the billet is then drawn to the final size wherein the filaments have the desired final small diameter. The material surrounding the filaments is then removed by suitable means leaving the filaments in the form of a tow.

U.S. Pat. No. 3,540,114 to Roberts et al. discloses a method of forming fine filaments formed of a material such as metal by multiple end drawing a plurality of elongated elements having thereon a thin film of lubricant material. The plurality of elements may be bundled in a tubular sheath formed of drawable material. The lubricant may be applied to the individual elements prior to the bundling thereof and may be provided by applying the lubricant to the elements while they are being individually drawn through a coating mechanism such as a drawing die. The lubricant comprises a material capable of forming a film having a high tenacity characteristic whereby the film is maintained under the extreme pressure conditions of drawing process. Upon completion of the constricting operation, the tubular sheath is removed. If desired, the lubricant may be also removed from the resultant filaments.

U.S. Pat. No. 3,698,863 to Roberts et al. discloses a metallic filament which has an effective diameter of less than 50 microns and is formed while surrounded by a subsequently removed sacrificial matrix. The filament has a preselected peripheral surface varying from substantially smooth to re-entrant and a preselected surface to volume ratio. The area of the filament also has a controlled non-uniformity along the length thereof which provides an acceptable dimensional tolerance. The metallic filament may be substantially one metal, bimetallic or tubular.

U.S. Pat. No. 3,977,069 to Domaingue, Jr. discloses that this invention contemplates a method and apparatus for taking fine metal fibers having a diameter range from 0.5 microns to approximately 150 microns and cutting the fibers into precise short lengths. The method and apparatus utilized first moistening tows of metal fibers, unwinding the tows from spools and positioning them into tow bands, stiffening the ribbon made from the tow bands, and cutting the fibers the desired precise lengths in order to prevent cold welding or deformation of the ends of the fibers during the cutting operation. Materials that may be used for stiffening the fibers include starch, PCA, ice, etc.

U.S. Pat. No. 3,977,070 to Schildbach discloses the method of forming a tow of filaments and the tow formed by said method wherein a bundle of elongated elements, such as rods or wires, is clad by forming a sheath of material different from that of the elements about the bundle and the bundle is subsequently drawn to constrict the elements to a desired small diameter. The elements may be formed of metal. The bundle may be annealed, or stress relived, between drawing steps as desired. The sheath may be formed of metal and may have juxtaposed edges thereof welded together to retain the assembly. The sheath is removed from the final constricted bundle to free the filaments in the form of tow.

U.S. Pat. No. 4,010,004 to Brown et al. discloses a metallic velvet material comprising a woven textile pile fabric wherein at least a portion of the woven base fabric and/or the velvet surface-forming pile yarns is metallic. The metallic yarn may comprise a blended yarn formed of staple metal fibers and conventional nonmetallic textile fibers, or may be formed of continuous metal filament material. The metal fibers, or filaments, are preferably formed with rough unmachined, unburnished, fracture-free outer surfaces for improved retention in the velvet pile fabric.

U.S. Pat. No. 4,109,709 to Honda et al. discloses heat pipes comprising an outer tubular material closed at both ends, a wick of metal fibers, an inner tubular material covered with the wick and inserted in the outer tubular material and a heat transfer volatile liquid confined in the closed outer tubular material. An evaporation region and a condensing region are respectively constituted in the end portions of the outer tubular material. The liquid in the evaporation region vaporizes when heated and the vapor is passed to the condensing region to condense while giving the heat of the vapor to other materials outside the heat pipe, and the condensed liquid is returned to the evaporation region by the capillary action of said wick, thus repeating a cycle of the evaporation and condensation.

U.S. Pat. No. 4,118,845 to Schildbach discloses the method of forming a tow of filaments and the tow formed by said method wherein a bundle of elongated elements, such as rods or wires, is clad by forming a sheath of material different from that of the elements about the bundle and the bundle is subsequently drawn to constrict the elements to a desired small diameter. The elements may be formed of metal. The bundle may be annealed, or stress relieved, between drawing steps as desired. The sheath may be formed of metal and may have juxtaposed edges thereof welded together to retain the assembly. The sheath is removed from the final constricted bundle to free the filaments in the form of tow.

U.S. Pat. No. 4,412,474 to Hara discloses a fiber cord comprises a core which is formed by braiding a plurality of strands, each comprising at least one fiber filament of high elongation. Around the core, an outer layer element is formed by braiding a plurality of strands, each comprising at least one fiber filament of low elongation and high strength. Around the outer layer element, a protective layer element is formed by braiding a plurality of strands, each comprising at least one fiber of high elongation.

U.S. Pat. No. 4,514,880 to Vaughn discloses a method and machine for forming nonwoven batts containing refractory fibers such as carbon, glass, ceramic or metallic fibers, includes a conveying table provided with scalloped rollers which separate tows of filaments and spread the filaments on a conveying table. A feed roller holds the filaments on the table so that they are conveyed to a rotating lickerin. The lickerin is provided with teeth which grasp the filaments so that a tensile force is applied thereto, thereby breaking the filaments at structurally weak points in the filaments. The fibers are mixed with textile fibers and transferred to a foraminous condenser by blowing the fibers through a duct. The fibers are arranged on the conveyor in a random fashion to form a batt.

U.S. Pat. No. 4,610,926 to Tezuka discloses a reinforcing steel fiber to be mixed in concrete having a shaft portion which has strength as a mother material. There are on both sides of the shaft portion, alternately formed knots expanding in width become increased in width in the direction towards the ends of the fiber while they become decreased in thickness while knots expanding in thickness extend almost uniformly over the full length.

U.S. Pat. No. 4,677,818 to Honda, deceased et al. a composite rope obtained by a process comprising (1) impregnating a fiber core of a reinforcing fiber bundle with a thermosetting resin, (2) coating the outer periphery of the resin-impregnated fiber core with fibers, and (3) curing the thermosetting resin with heat.

U.S. Pat. No. 4,771,596 to Klein discloses a fine heterogeneous hybrid spun yarn is blended from electrostatically conductive staple fibers and electrostatically non-conductive staple fibers and electrostatically non-conductive staple fibers so that the yarn is electrostatically conductive only over short discrete lengths. When used in pile fabrics, such as carpets, the fine yarn, is introduced with at least some of the carpet facing yarns during the carpet making operations. The resultant carpet structure substantially eliminates electrostatic shock to a human walking across the carpet and approaching a ground such as a light switch, radio, and approaching a ground such as a light switch, radio, or another person. Such a carpet does not constitute a dangerous floor covering. The unique heterogeneous hybrid spun blended yarn is achieved by process techniques completely contrary to accepted blending practices.

U.S. Pat. No. 4,779,322 to Michel Dendooven discloses a crimping process of metal fibers between the engaging pairs of gear rollers. The fibers are first embedded in a ductile and coherent matrix material. After applying a permanent crimping wave deformation on this composite, the matrix material is removed. The crimped fibers can subsequently be transformed to a metal fiber web. The crimped fibers can also easily be blended with textile fibers in order to form, e.g., antistatic blended yarn.

U.S. Pat. No. 5,525,423 to Liberman et al. discloses an apparatus and method for an improved fiber tow having plural diameter metallic wires, comprising the drawing of a first cladded metallic wire to provide a first drawn cladding of reduced diameter. The first cladding is separated into a primary portion and a secondary with the secondary portion being drawn to reduce further the diameter. A selected mixture of the primary and the secondary portions are cladded to provide a third cladding of reduced diameter. The third cladding is drawn and the claddings are removed to provide a fiber tow comprising metallic wires having a major diameter and a minor diameter. The fiber tow may be severed into uniform length to provide slivers of metallic wires having plural diameters. The plural diameter slivers may be used for various purposes including a filter medium or may be encapsulated within polymeric material for providing an electrically conductive metallic layer therein.

U.S. Pat. No. 5,584,109 to DiGiovanni et al. discloses an improved battery plate and method of making for an electric storage battery. The battery plate comprises a plurality of metallic fibers of a single or plural diameters randomly oriented and sintered to provide a conductive battery plate with a multiplicity of pores defined therein. The metallic fibers are formed by cladding and drawing a plurality of metallic wires to provide a fiber tow. The fiber tow is severed and the cladding is removed to form metallic fibers. The metallic fibers are arranged into a web and sintered to form the battery plate.

U.S. Pat. No. 5,630,700 to Olsen et al. discloses a turbine nozzle including outer and inner bands having respective mounting therein. A plurality of vanes extends through respective pairs of outer and inner holes in the bands. The vane outer and inner ends are resiliently supported to the bands to allow differential thermal movement therebetween so that the individual vanes float relative to the outer and inner bands to prevent thermal stress failure thereof.

U.S. Pat. No. 5,707,467 to Matsumaru et al. discloses a high elongation compact helical steel cord with a high degree of elongation at break of not less than 5% has a (1×n) structure comprising three or more base wires which are helically preformed at a predetermined pitch and which are twisted in the same direction and at the same pitch so that the ratio P/D of the cord diameter D to the twisting pitch P is in the range of 8-15 with the base wire preforming pitch being shorter than the cord twisting pitch. The finished cord has a helical composite structure with its elongation under a load of 35 kgf/mm² being 0.71%-1.00% and that under a load of 70 kgf/mm² being 1.18%-1.57%. A radial tire is reinforced with the steel cord preferably as a steel belt cord. An appartaus for making the steel cord is provided with revolving preformers on the wire introducing portion of a bunching machine such that the bunching machine is rotated in a direction reverse to the rotational direction of the revolving preformers.

U.S. Pat. No. 5,722,226 to Matsumaru discloses a steel cord effective for reinforcing a super-large off-road tire wherein strands made by simultaneously twisting together 3 to 6 steel wires in the same twisting direction with the same pitch length are used and the steel wires in the same twisting direction with the same pitch length are used and the steel cord is made by twisting together 3 to 6 such strands in the same direction as the twisting direction of the strands and with the same pitch length. Each of the steel wires consulting the strands continuously has a small wavy pattern of a pitch length smaller than the lay length of the strands and therefore each of the strands has a compound pattern comprising a wavy pattern formed by the twisting. The small wavy pattern and a gap is formed between steel wires each of the strands by the small wavy pattern. The lay length P₁ of the strands is defined by the small wavy pattern. The lay length P₁ of the steel cord is 8 to 15 the steel cord diameter D and the elongation on breakage by tension of the steel cord is over 5%.

U.S. Pat. No. 5,802,830 to Kawatani discloses that the present invention relates to a steel cord comprising two core wires and five outer wires each having a diameter larger than that of each core wire and integrally twisted on the score wires, wherein a strand constituted by the five outer wires and the two core wires has an oblong cross-section.

U.S. Pat. No. 5,839,264 to Uchio discloses that the steel cord for reinforcement of an off-road tire has a superior resistance to penetration and durability with respect to sharp objects. It has a 3×3, a 3×4, a 4×3 or a 4×4 structure, an identical cord diameter at all points along the steel cord in a longitudinal direction, a cord lay length equal to from 3.5 to 7.5 times the cord diameter and an elongation at break of at least 4%. The steel cord is made up of element wires, each having a wire diameter of from 0.3 to 0.5 mm and a tensile strength of from 2000 to 3300 Mpa.

U.S. Pat. No. 5,888,321 to Kazama et al. discloses the steel wire for making steel cord used in rubber product reinforcement has a tensile strength, Y in N/mm², such that Y≧−1960 d=3920, wherein d is the wire diameter in mm, and also a flat Vickers hardness distribution in a cross-section perpendicular to a length direction thereof from the surface to the interior, but excluding a central portion having a central portion diameter corresponding to ¼ of the wire diameter. The steel wire is made by a method including wet drawing a carbon steel wire rod material containing 0.80 to 0.89% by weight carbon to a predetermined intermediate diameter and subsequently heat-treating and plating to form a final raw material and then wet drawing the final raw material to form the steel wire. The wet drawing steps are performed with drawing dies, each of which is provided with a drawing hold having a drawing hold diameter d₁ and the drawing die has an approach angle 2α equal to from 8° to 10° and a bearing length of 0.3 d₁. The wet drawing of the final raw material includes a final drawing step performed with a double die and the steel wire immediately after passing through the final drawing die has its temperature controlled so as to be less than 150° C.

U.S. Pat. No. 5,890,272 to Liberman et al. discloses a process for making fine metallic fibers comprising coating a plurality of metallic wires with a coating material. The plurality of metallic wires are jacketed with a tube for providing a cladding. The cladding is drawn for reducing the outer diameter thereof. The cladding is removed to provide a remainder comprising the coating material with the plurality of metallic wires contained therein. The remainder is drawn for reducing the diameter thereof and for reducing the corresponding diameter of the plurality of metallic wires contained therein. The coating material is removed for providing the plurality of fine metallic fibers.

U.S. Pat. No. 5,956,935 to Katayama et al. discloses that the steel wire is made using a carbon steel wire rod material containing 0.70 to 0.75 wt % carbon and has the characteristics that its diameter is 0.10 to 0.40 mm and Y≧−1960 d+3580 [Y:tensile strength (N/mm₂), d: diameter (mm)]. Furthermore, the torque decrease factor of the steel wire is less than 7% in a torsion-torque curve in a torsion-torque test wherein forward twisting and then reverse twisting are applied. A preferred steel cord has two steel wires bundled together substantially in parallel and one steel wire is wound around this bundle. This steel cord is made from steel wires having the diameter, tensile strength and toughness characteristics set forth above, and also the ratio B/A of the strength B of the twisted steel cord to the aggregate strength A of the steel wires before they are twisted together into the steel cord is 0.935 or over.

Therefore it is an object of this invention to provide an apparatus and a process for producing high quality metallic fiber tow, which eliminates the difficulties in leaching of continuous cladding heretofore known in the art.

Another object of this invention is to provide an apparatus and a process for producing high quality metallic fiber tow that eliminates the need for twisting the cladding and untwisting the metallic fiber tow in a batch process.

Another object of this invention is to provide an apparatus and a process for producing high quality metallic fiber tow that produces very high quality metallic fiber tow through a conventional batch process.

Another object of this invention is to provide an apparatus and a process for producing high quality metallic fiber tow that utilizes a pretreatment of the cladding material prior to leaching which inhibits the fibers of the fiber tow from being ensnared with adjacent metallic fibers of the fiber tow.

Another object of this invention is to provide an apparatus and a process for producing high quality metallic fiber tow that produces high quality metallic fiber tow with minimal broken fibers.

Another object of this invention is to provide an apparatus and a process for producing high quality metallic fiber tow that is capable of producing high quality fiber tow in commercial quantities at a reasonable manufacturing cost.

The foregoing has outlined some of the more pertinent objects of the present invention. These objects should be construed as being merely illustrative of some of the more prominent features and applications of the invention. Many other beneficial results can be obtained by applying the disclosed invention in a different manner or modifying the invention within the scope of the invention. Accordingly other objects in a full understanding of the invention may be had by referring to the summary of the invention, the detailed description describing the preferred embodiment in addition to the scope of the invention defined by the claims taken in conjunction with the accompanying drawings.

### SUMMARY OF THE INVENTION

A specific embodiment of the present invention is shown in the attached drawings. For the purpose of summarizing the invention, the invention relates to an improved apparatus and process for making fine metallic fiber tow comprising the steps of cladding an array of metallic wires with an array cladding material to provide an array cladding. The array cladding is drawn for reducing the diameter thereof and for reducing the corresponding diameters of each of the metallic wires of the array within the array cladding for producing an array of fine metallic fibers. A series of bends is formed in the array cladding. The array cladding is placed onto a support with the series of bends creating spaces between adjacent portions of the array cladding to minimize the number of direct contacts between adjacent portions of the array cladding. The array cladding material is removed for producing metallic fiber tow.

In a more specific embodiment of the invention, the step of cladding the array of metallic wires includes cladding a wire with a wire cladding material to provide a wire cladding. The wire claddings are assembled and are clad with the array cladding material to provide the array cladding. The step of drawing the array cladding may include a multiple drawing and annealing process for producing an array of fine metallic fibers.

In another specific embodiment of the invention, the step of cladding the array of metallic wires includes electroplating a wire with a wire cladding material to provide a wire cladding. An array of the wire claddings is assembled and clad with the array cladding material to provide an array cladding. The step of removing the array cladding material includes chemically removing the array cladding material from the array of fine metallic fibers for producing fine metallic fiber tow.

Preferably, the step of forming a series of bends in the array cladding includes forming a series of bends along the longitudinal length of the array cladding bends for minimizing the direct contact between adjacent portions of the array cladding. In one embodiment of the invention, the step of forming a series of bends in the array cladding includes forming a series of bends two dimension perpendicular to a third dimension extending along the longitudinal length of the array cladding. In another embodiment of the invention, the step of forming a series of bends in the array cladding includes forming a continuous helical bend in the array cladding. In still another embodiment of the invention, the step of forming a series of bends in the array cladding includes forming a continuous sinusoidal bend in the array cladding

In another specific example of the invention, the array cladding is placed onto a support. The placing of the array cladding onto the support may include winding the array cladding onto a porous cylindrical spool or reel for enabling the array cladding material to be chemically removed from the array of fine metallic fibers for producing fine metallic fiber tow.

The invention is also incorporated into an apparatus for bending a continuous wire, comprising a feeder for feeding the continuous wire. A bender forms a bend in the continuous wire and a receiver receives the bent continuous wire.

In one example of the invention, the bender comprises as plurality of rollers each having a roller axis. The plurality of rollers are located with the roller axes being substantial parallel and with adjacent rollers being offset from one another. The plurality of rollers receive the continuous wire between adjacent rollers for forming a continuous bend in the continuous wire upon movement of the continuous wire. The receiver receives the bent continuous wire from the plurality of rollers.

In another example of the invention, the bender comprises a rotating bender having a bender rotational axis substantially parallel to the continuous wire emanating from the feeder. The bender has a bender guide located radially outward from the bender rotational axis. The bender guide receives the continuous wire for forming a continuous bend in the continuous wire upon rotation of the bender. The receiver receives the bent continuous wire from the bender.

In another example of the invention, the bender comprises hammer movably mounted relative to an anvil. The bender guide receives the continuous wire between the hammer and the anvil for forming a series of bends in the continuous wire upon movement of the hammer. The receiver receives the bent continuous wire from the bender.

The foregoing has outlined rather broadly the more pertinent and important features of the present invention in order that the detailed description that follows may be better understood so that the present contribution to the art can be more fully appreciated. Additional features of the invention will be described hereinafter which form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

FIG. 1 is a block diagram illustrating a process for making fine metallic fiber tow;

FIG. 2 is an isometric view of a metallic wire referred to in FIG. 1;

FIG. 2A is an enlarged end view of FIG. 2;

FIG. 3 is an isometric view of the metallic wire of FIG. 1 after a wire cladding process;

FIG. 3A is an enlarged end view of FIG. 3;

FIG. 4 is an isometric view of the an array of the wire claddings of FIG. 3;

FIG. 4A is an end view of FIG. 4;

FIG. 5 is an isometric view of the array of the wire claddings of FIG. 4 after an array cladding process;

FIG. 5A is an end view of FIG. 5;

FIG. 6 is an isometric view of the array cladding of FIG. 5 after a drawing process;

FIG. 6A is an enlarged end view of FIG. 6;

FIG. 7 is an isometric view of the drawn array cladding of FIG. 6 after a bending process;

FIG. 7A is an end view of FIG. 7;

FIG. 8 is an isometric view of the bent array cladding of FIG. 7 disposed on a support;

FIG. 8A is a side view of FIG. 8;

FIG. 8B is an end view of FIG. 8;

FIG. 9 is an isometric view similar to FIG. 8 after removal of the array cladding material and the wire cladding material leaving a fine metallic fiber tow;

FIG. 9A is a side view of FIG. 9;

FIG. 9B is an end view of FIG. 9;

FIG. 10A is a block diagram of a first apparatus for making continuous bends in the array cladding;

FIG. 10B is a block diagram of a second apparatus for making intermittent bends in the array cladding;

FIG. 11 is an isometric view of a first example of the first apparatus shown in FIG. 10A;

FIG. 12 is an isometric view of a second example of the first apparatus shown in FIG. 10A;

FIG. 13 is an elevational view of the actual size of the bent array cladding of FIG. 7;

FIG. 14 is a photograph of fine metallic fiber tow of FIG. 9;

FIG. 15 is a side elevational view of a first example of the second apparatus shown in FIG. 10B;

FIG. 16 is a view similar to FIG. 15 illustrating the intermittent bending of the array cladding;

FIG. 17 is a magnified view of a portion of FIG. 15;

FIG. 18 is a magnified view of a portion of FIG. 16;

FIG. 19 is an elevational view of a bent array cladding from the first example of the second apparatus shown in FIG. 15-18;

FIG. 20 is a side view partially in section of a second example of the second apparatus shown in FIG. 10B;

FIG. 21 is a view along line 21-21 in FIG. 20;

FIG. 22 is a view along line 22-22 in FIG. 20;

FIG. 23 is a magnified view of a portion of FIG. 20;

FIG. 24 is a view similar to FIG. 23 illustrating the intermittent bending of the array; and

FIG. 25 is an elevational view of a bent array cladding from the second example of the second apparatus shown in FIGS. 20-24.

Similar reference characters refer to similar parts throughout the several Figures of the drawings.

### DETAILED DISCUSSION

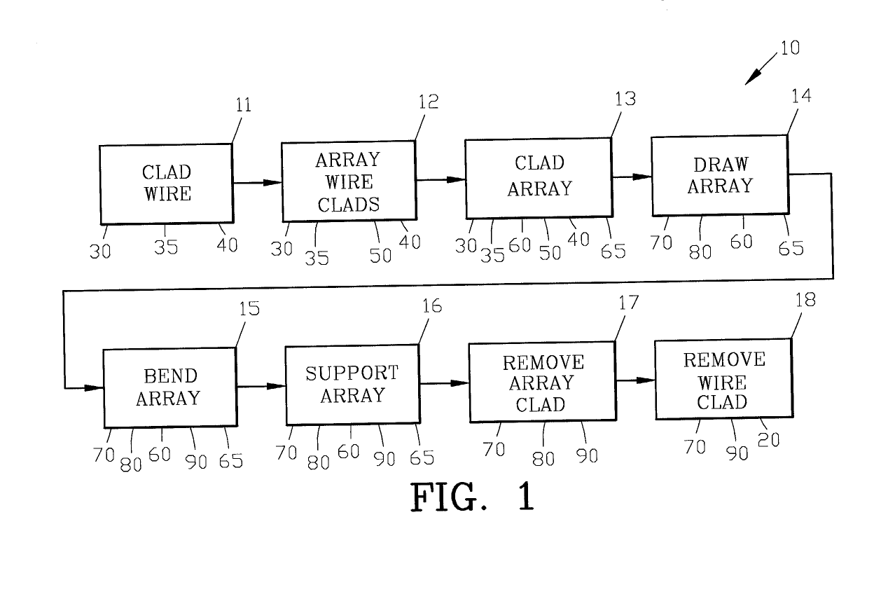

FIG. 1 is a block diagram illustrating a process 10 for making fiber tow 20 such as a fine metallic fiber tow 20. The process 10 of FIG. 1 comprises providing a metallic wire 30 selected of a material suitable for making the fine metallic fiber tow 20.

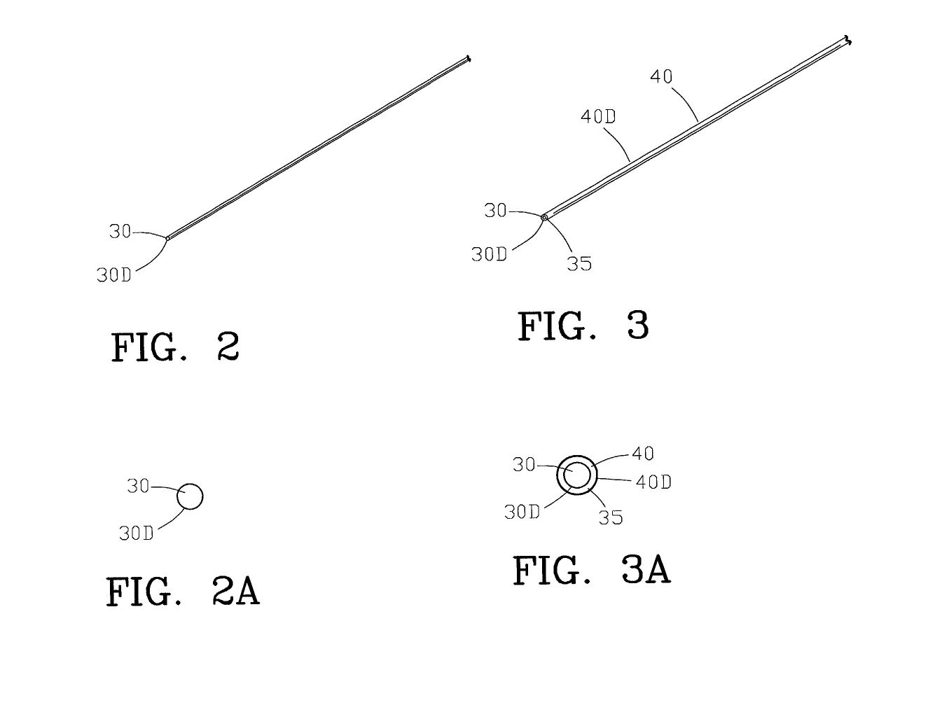

FIGS. 2 and 2A are isometric and enlarged end views of the metallic wire 30 referred to in FIG. 1. In this example, the metallic wire 30 is shown as a solid wire having an outer diameter 30D. The metallic wire 30 may be an elemental wire such as nickel, an alloy wire such as stainless steel or inconel, or a composite wire such as copper and stainless steel. In this example, the metallic wire 30 is a stainless steel wire but it should be understood that various types of materials may be used in the process 10.

FIG. 1 illustrates the process step 11 of cladding the metallic wire 30 with a wire cladding material 35 to provide a wire cladding 40. The wire cladding material 35 may be applied to the metallic wire 30 by a conventional cladding process or by an electroplating process.

FIGS. 3 and 3A are isometric and end views of the wire cladding 40 referred to in FIG. 1. The wire cladding material 35 is applied to the outer diameter 30D of the metallic wire 30. The wire cladding 40 defines an outer diameter 40D.

The process of applying the wire cladding material 35 to the metallic wire 30 may be accomplished in various ways. Preferably, the process of applying the wire cladding material 35 to the metallic wire 30 is an electroplating process with the wire cladding material 35 representing approximately ten percent (10%) by weight of the combined weight of the metallic wire 30 and the wire cladding material 35.

In this example, the wire cladding material 35 is a copper material but it should be understood that various types of cladding materials 35 may be used in the process 10. For example, the wire cladding material 35 may be carbon steel.

Another preferred process of applying the wire cladding material 35 to the metallic wire 30 is a conventional cladding process. In a conventional cladding process, a strip of the wire cladding material 35 is bent about the metallic wire 30 with the opposed edges of the strip of the wire cladding material 35 abutting one another. The abutting opposed edges of the strip of the wire cladding 35 are welded to one another.

In another example of the invention, the metallic wire 30 is encased within the wire cladding material 35 to form the wire cladding 40 having a diameter 40D. The wire cladding material 35 is a preformed tube with the metallic wire 30 being inserted within the wire cladding 35 to form the wire cladding 40.

FIG. 1 illustrates the process step 12 of assembling an array 50 of a plurality of the wire claddings 40. The plurality of wire claddings 40 are assembled in a manner suitable for forming an array cladding 60. Preferably, 150 to 3000 of the wire claddings 40 are assembled into the array 50.

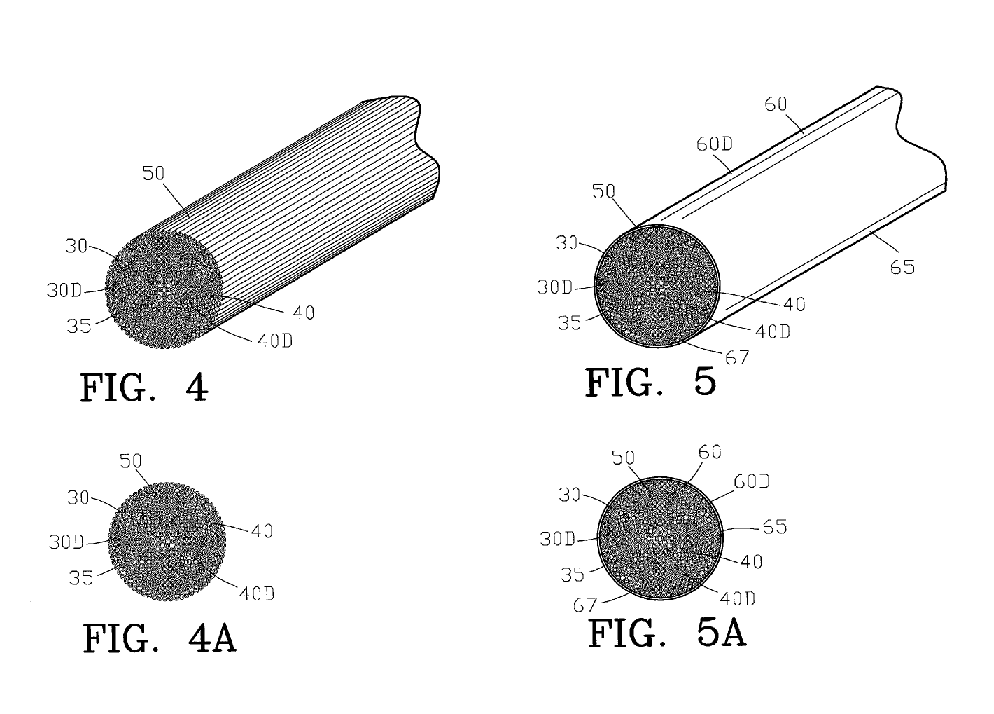

FIGS. 4 and 4A are isometric and end views of the assembly 50 of a plurality of the wire claddings 40 after the assembly process 12 of FIG. 1. Preferably, the plurality of the wire claddings 40 are arranged in a substantially parallel configuration to form the array 50 of the multiplicity of the wire claddings 40. In this example, the plurality of wire claddings 40 are assembled to have a substantially circular cross-section.

FIG. 1 illustrates the process step 13 of cladding the array 50 of the plurality of the wire claddings 40 to form an array cladding 60. The array 50 of the plurality of the wire claddings 40 is encased within an array cladding material 65 to form the array cladding 60. The array 50 of the plurality of the wire claddings 40 are encased within the array cladding material 65 to have a diameter 60D.

In one example of the invention, a strip of the array cladding material 65 is bent about the array 50 of the plurality of the wire claddings 40 with opposed edges of the strip of the array cladding material 65 abutting one another. The abutting opposed edges of the strip of the array cladding material 65 are welded to one another. In another example of the invention, the array cladding material 65 is a preformed tube with the array 50 of the plurality of the wire claddings 40 being inserted within the array cladding material 65.

FIGS. 5 and 5A are isometric and end views illustrating the completed process of cladding the array 50 of the plurality of the wire claddings 40 within the array cladding material 65 to provide the array cladding 60. The array cladding material 65 may be made of various metallic materials. In one example, the array cladding material 65 is made of a carbon steel material. In another example, the array cladding material 65 is made of the same material as the wire cladding material 35 of the wire claddings 40.

FIG. 1 illustrates the process step 14 of drawing the array cladding 60. The process step 14 of drawing the array cladding 60 may include a multiple drawing and annealing process for producing an array of fine metallic fibers 70 within the array cladding 60.

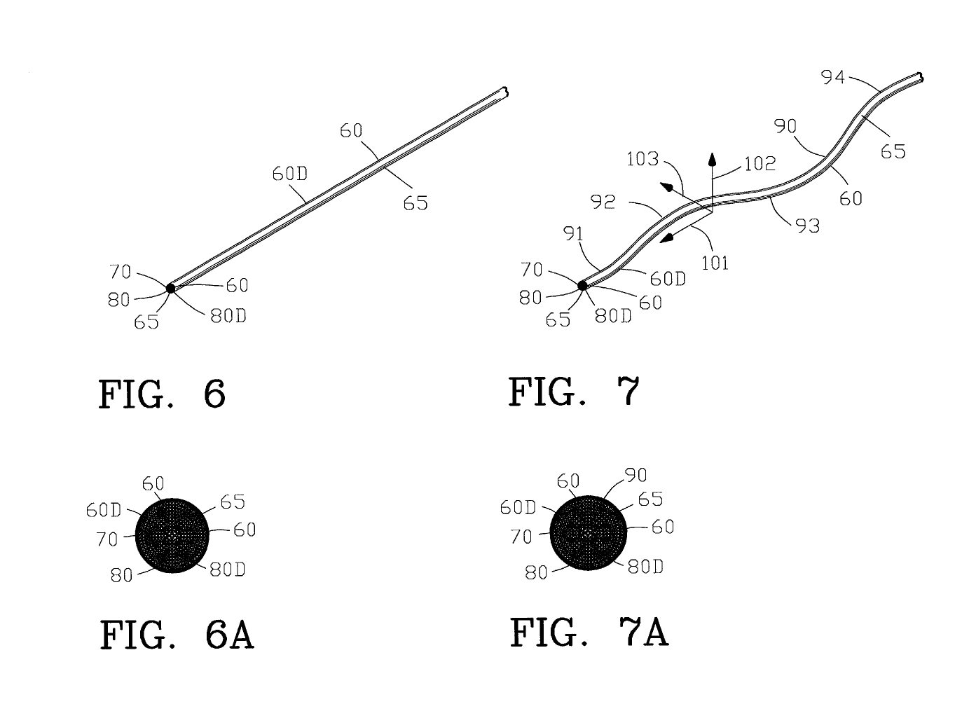

FIGS. 6 and 6A are isometric and end views of the array cladding 60 of FIG. 5 after the drawing process 14 of FIG. 1. The process step 14 of drawing the array cladding 60 may provide three effects. Firstly, the process step 14 reduces an outer diameter 60D of the array cladding 60. Secondly, the process step 14 reduces the corresponding outer diameter 40D of each of the plurality the wire claddings 40 and the corresponding outer diameter 30D of each of the metallic wires 30 to provide fine metallic fibers 70. Thirdly, the process step 14 may cause the wire cladding material 35 on each of the metallic wires 30 to diffusion weld with the wire cladding material 35 on adjacent metallic wire 30. The diffusion welding of the wire claddings 35 forms a unitary material 80 with the array of the fine metallic fibers 70 contained therein. The plurality of the fine metallic fibers 70 are contained within the unitary material 80 extending throughout the interior of the array cladding 60. The unitary material 80 defines an outer diameter 80D.

In one example of the invention, the wire cladding material 35 is a copper material and is diffusion welded within the array cladding 60 to form the substantially unitary copper material 80 with the plurality of the fine metallic fibers 70 contained therein. When the array cladding material 65 is formed from the same material as the wire cladding material 35, the array cladding material 65 is diffusion welded along with the wire claddings 35. The wire cladding material 35 and the array cladding material 65 form the unitary material 80 with the array of the fine metallic fibers 70 contained therein.

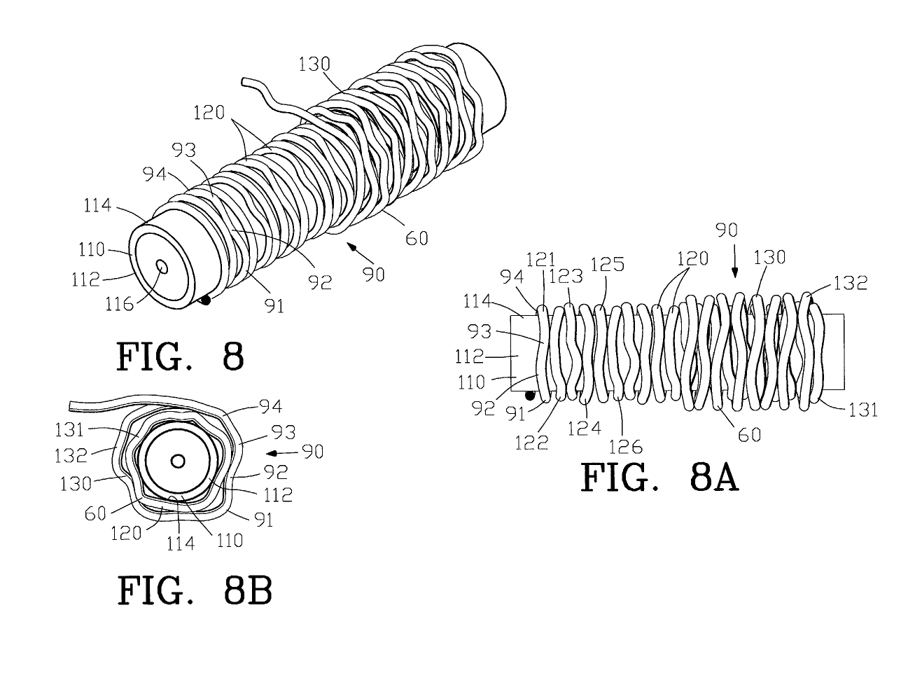

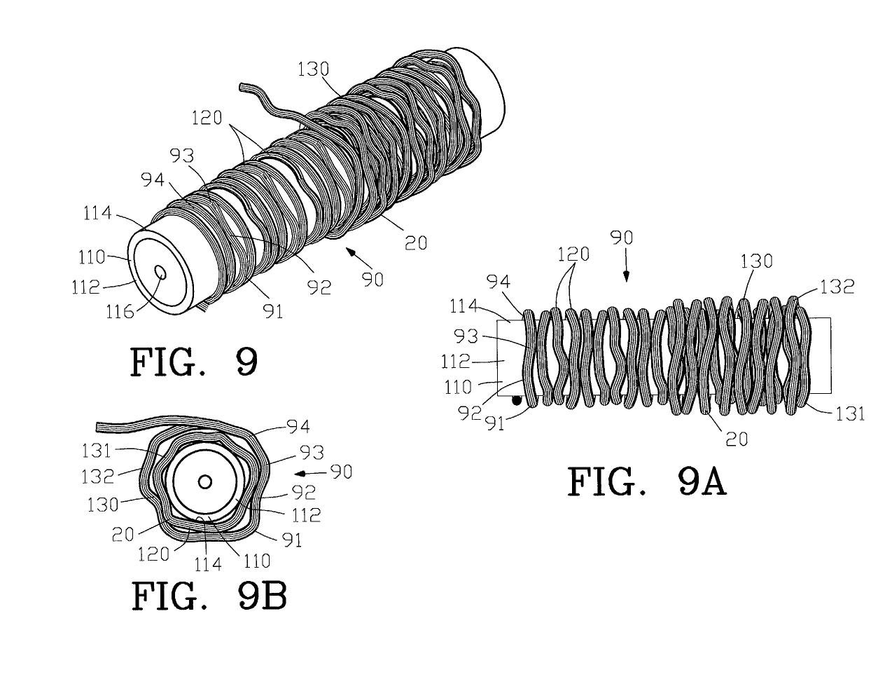

FIG. 1 illustrates the process step 15 of creating a bend 90 in the array cladding 60. Preferably, the process step 15 includes creating a series of bends 90 extending along the longitudinal length of the array cladding 60. As will be described in greater detail hereinafter with reference to FIGS. 8 and 9, the series of bends 90 in the array cladding 60 reduce interaction between adjacent portions of the array cladding 60. The series of bends 90 are shown as bends 91-94.

FIGS. 7 and 7A are isometric and end views of the array cladding 60 of FIG. 6 after the bending process 15. In this example of the invention, the series of bends 90 comprises a series of bends 91-94 formed along the longitudinal length of the array cladding 60. In one example, a series of continuous bends 91-94 are formed in the array cladding 60. The series of continuous bends 91-94 may be formed periodically at a substantially fixed frequency, period or wavelength along the longitudinal length of the array cladding 60. In another example, a series of intermittent bends are formed in the array cladding 60. The series of intermittent bends may be formed periodically at a substantially fixed frequency, period or wavelength along the longitudinal length of the array cladding 60.

The longitudinal length of the array cladding 60 extends along a first dimension 101. A second dimension 102 extends perpendicular to the first dimension 101. A third dimension 103 extends perpendicular to the first and second dimensions 101 and 102 as conventional three dimensional cartesian coordinates.

In one example of the invention, the series of bends 91-94 in the array cladding 60 are formed continuously along the first dimension 101 and are contained substantially within the second dimension 102. The series of bends 91-94 in the array cladding 60 may be formed in the shape of a continuous sinusoidal bend extending along the first dimension 101. The continuous sinusoidal bend 90 in the array cladding 60 has an approximate wavelength of 1.5 to 4.0 inches and has an approximate amplitude of 0.125 to 0.25 inches.

In another example of the invention, the series of bends 91-94 in the array cladding 60 are formed continuously along the first dimension 101 and are contained within both the second dimension 102 and the third dimension 103. The series of bends 91-94 in the array cladding 60 may be formed in the shape of a continuous helical bend extending along the first dimension 101. The continuous helical bend in the array cladding 60 has an approximate wavelength of 1.5 to 4.0 inches and has an approximate amplitude of 0.125 to 0.25 inches.

In another example of the invention, the series of bends 91-94 in the array cladding 60 are formed intermittently along the first dimension 101 and are contained within the second dimension 102 and/or the third dimension 103. The series of bends 91-94 in the array cladding 60 may be formed in the shape of a series of depressions, bends or crimps extending along the first dimension 101.

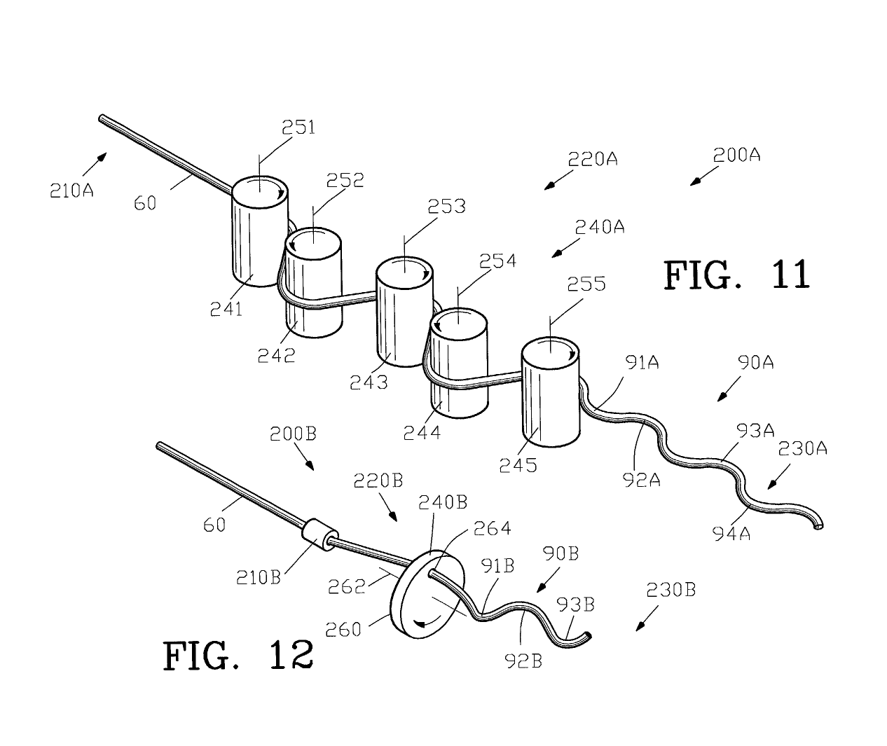

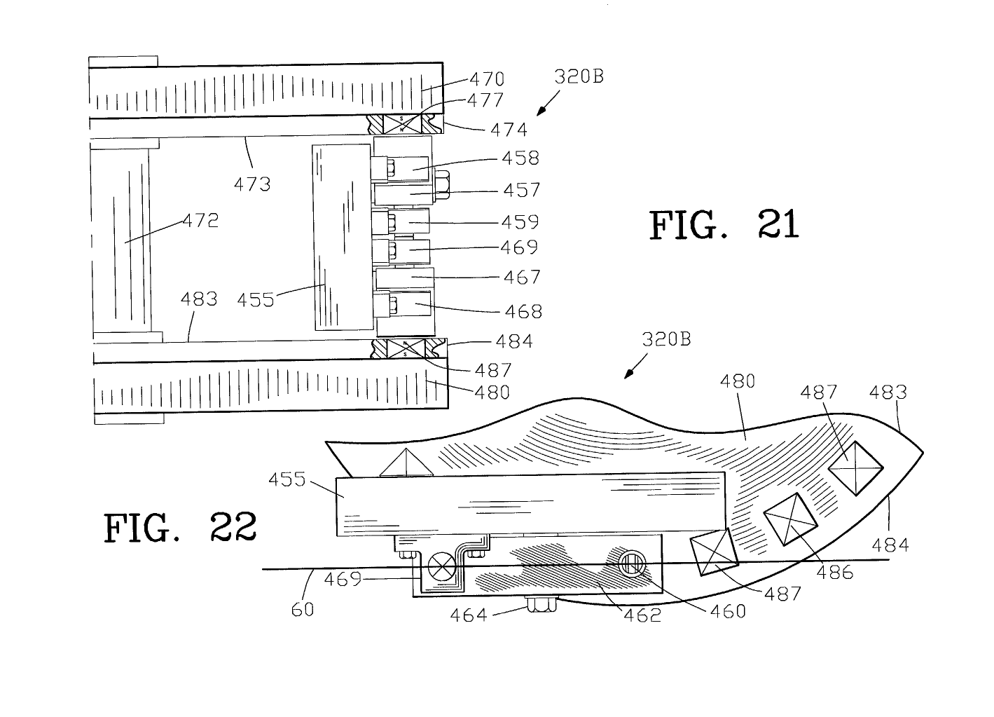

Although the bends 90 have been set forth herein as a continuous sinusoidal bend or a continuous helical bend or an intermittent series of depressions, bends or crimps, it should be understood that numerous other types of bends 90 may be utilized with the present invention. The numerous other types of bends may be formed by controlling the speed of the bending apparatus as well as controlling the speed of the array cladding passing through the bending apparatus as will be described in greater detail with reference to FIGS. 11-25.

FIG. 1 illustrates the process step 16 of supporting the array cladding 60. The process step 16 includes supporting the array cladding 60 for facilitating the removal of the wire clad 40 and the array clad 60. Preferably, the process step 16 of supporting the array cladding 60 includes supporting the array clad 60 to expose substantially all regions of the array cladding 60 for enabling total removal of the wire clad 40 and the array clad 60.

FIG. 8 is an isometric view of the array clad 60 disposed upon a support 110 prior to the removal of the wire clad 40 and the array clad 60. In this example, the support 110 is shown as a cylindrical spool or a cylindrical reel 112 having a diameter 114. The spool 112 is rotatable about an axis 116 for enabling the array clad 60 to be wound upon the spool 112. Preferably, the spool 112 is porous for enabling chemicals to pass therethrough for facilitating the chemical removal of the array cladding material 65 from the array cladding 60.

In this example, the array clad 60 is wound around the diameter 114 of the spool 112 for the removal of the wire clad 40 and the array clad 60. The array clad 60 is wound about the diameter 114 of the spool 112 in a series of adjacent lateral windings 120. The array clad 60 is further wound upon the series of adjacent lateral windings 120 to form a series of adjacent winding courses 130.

The series of bends 90 in the array cladding 60 reduce interaction between adjacent lateral windings 120 of the array cladding 60. The series of bends 90 in the array cladding 60 creates spaces between adjacent lateral windings 120 of the array cladding 60. The spaces created between adjacent lateral windings 120 of the array cladding 60 reduce the interaction between adjacent lateral windings 120 of the array cladding 60 by minimizing the amount of parallel contact between adjacent lateral windings 120.

The series of bends 90 in the array cladding 60 reduce interaction between adjacent winding courses 130 of the array cladding 60. The series of bends 90 in the array cladding 60 create spaces between adjacent winding courses 130 of the array cladding 60. The spaces created between adjacent winding courses 130 of the array cladding 60 reduce the interaction between adjacent winding courses 130 by minimizing the amount of circumferential contact between adjacent winding courses 130.

FIG. 8A is a side view of FIG. 8 illustrating the series of bends 91-94 shown in FIG. 7 minimizing the amount of parallel contact between adjacent lateral windings 120 shown as adjacent lateral windings 121-126. The series of bends 91-94 allow only a minority of the length of the adjacent lateral windings 120 to contact with an adjacent length of an adjacent lateral winding 120. For example, the sinusoidal bends 90 referred with reference to FIG. 7 separate adjacent winding portions of the minimizing the amount of parallel contact between adjacent lateral windings 121-126.

FIG. 8B is an end view of FIG. 8 illustrating the series of bends 91-94 shown in FIG. 7 minimizing the amount of circumferential contact between adjacent winding course 130 shown as concentric winding courses 131 and 132. The series of bends 91-94 allow only a minority of the length of a concentric winding course 131 to contact with the adjacent length of a concentric winding course 132. For example, the helical bends 90 referred to with reference to FIG. 7 separate adjacent winding course 131 to minimizing the amount of circumferential contact between concentric winding courses 132.

FIG. 1 illustrates the process step 17 of removing the array cladding 60. The process step 17 of removing the array cladding 60 comprises removing the array cladding material 65 from the unitary material 80 containing the fine metallic fibers 70. The array clad 60 may be removed in a number of ways including the removal by a chemical or electrochemical removal process. In one example, the array clad 60 disposed upon the support 110 is immersed into a container for treatment by the chemical or electrochemical removal process. After the removal of the array cladding material 65, the wire cladding material 35 forming the unitary material 80 supports the fine metallic fibers 70.

FIG. 1 illustrates the process step 18 of removing the wire cladding material 35 forming the unitary material 80. The process step 18 of removing the wire cladding material 35 comprises removing the wire cladding material 35 from the fine metallic fibers 70. The wire cladding material 35 may be removed in a number of ways including the removal by a chemical or electrochemical removal process. In one example, the wire cladding material 35 disposed upon the support 110 is immersed into a container for treatment by the chemical or electrochemical removal process. After the removal of the wire cladding material 35, the fine metallic fibers 70 are supported by the support 110.

In one alternative to the present invention, the process step 18 of removing the wire cladding material 35 may be performed serially or concurrently with the process step 17 of removing the array cladding material 65. In this example, the array cladding material 65 and the wire cladding material 35 are immersed into a container for treatment by the chemical or electrochemical removal process. The chemical or electrochemical removal process may first remove the array cladding material 65 and secondly remove the wire cladding material 35. In the alternative the chemical or electrochemical removal process may remove simultaneously the array cladding material 65 and the wire cladding material 35. The simultaneous removal of the array cladding material 65 and the wire cladding material 35 is most easily affected when the array cladding material 65 and the wire cladding material 35 are formed of the same material.

In another alternative to the present invention, the process step 17 of removing the array cladding materials 65 may be performed prior to the process step 15 bending. In this example, the array cladding material 65 is removed by suitable means such as a chemical removal process, electrochemical removal process, or mechanical removal process. The removal of the array cladding material 65 leaves the unitary material 80 with the fine metallic fibers 70 contained therein. The unitary material 80 is subjected to the process step 16 of supporting the unitary material 80 on the support 110. Thereafter, the wire cladding material 35 may be removed in the process step 18 as set forth above.

FIG. 9 is an isometric view of the continuous fiber tow 20 disposed upon a support 110. The continuous fiber tow 20 comprises the array of fine metallic fibers 70 after the removal of the wire cladding material 35 and the array cladding material 65. The continuous fiber tow 20 is formed by removing the wire cladding material 35 and the array cladding material 65 on the support 110 leaving only the array of fine metallic fibers 70.

FIG. 9A is a side view of FIG. 9 illustrating the series of bends 91-94 minimizing the amount of parallel contact between adjacent lateral windings 120 of the continuous fiber tow 20. The series of bends 91-94 allow only a minority of the length of the adjacent lateral windings 120 to contact with an adjacent length of an adjacent lateral winding 120 of the continuous fiber tow 20.

FIG. 9B is an end view of FIG. 9 illustrating the series of bends 91-94 minimizing the amount of circumferential contact between adjacent winding courses 130 of the continuous fiber tow 20. The series of bends 91-94 allow only a minority of the length of a winding course 131 to contact with the adjacent length of a winding course 132. The continuous fine metallic fiber tow 20 produced by the process of the present invention is of an extremely high quality. The continuous fiber metallic fiber tow 20 lacks the entanglement and broken metallic fibers normally encountered in fine metal fiber tow.

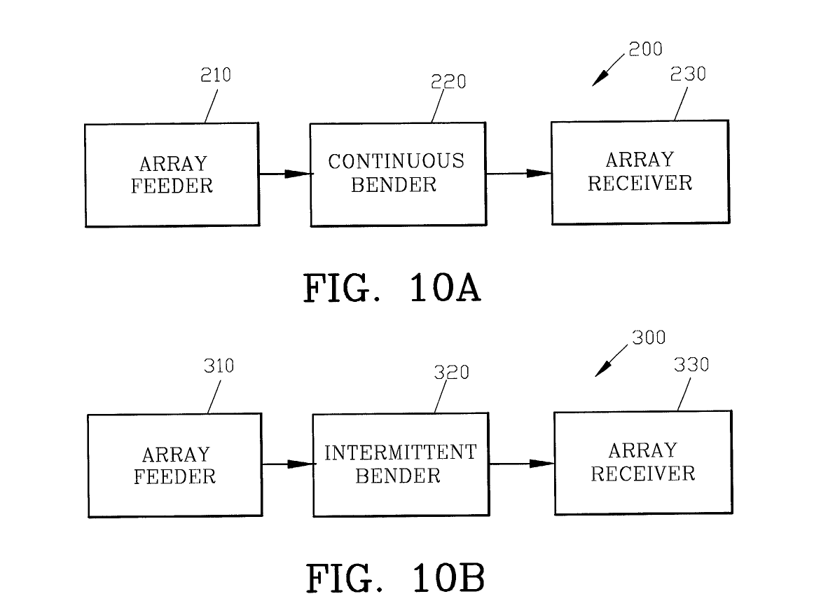

FIG. 10A is a block diagram of a first apparatus 200 for making continuous bends in the array cladding 60. The first apparatus 200 comprises an array feeder 210 for feeding the array cladding 60 to a bender 220. In the first apparatus 200, the bender 220 is a continuous bender 220 for continuously bending the array cladding 60. The first apparatus 200 will be more fully explained with reference to FIGS. 11 and 12.

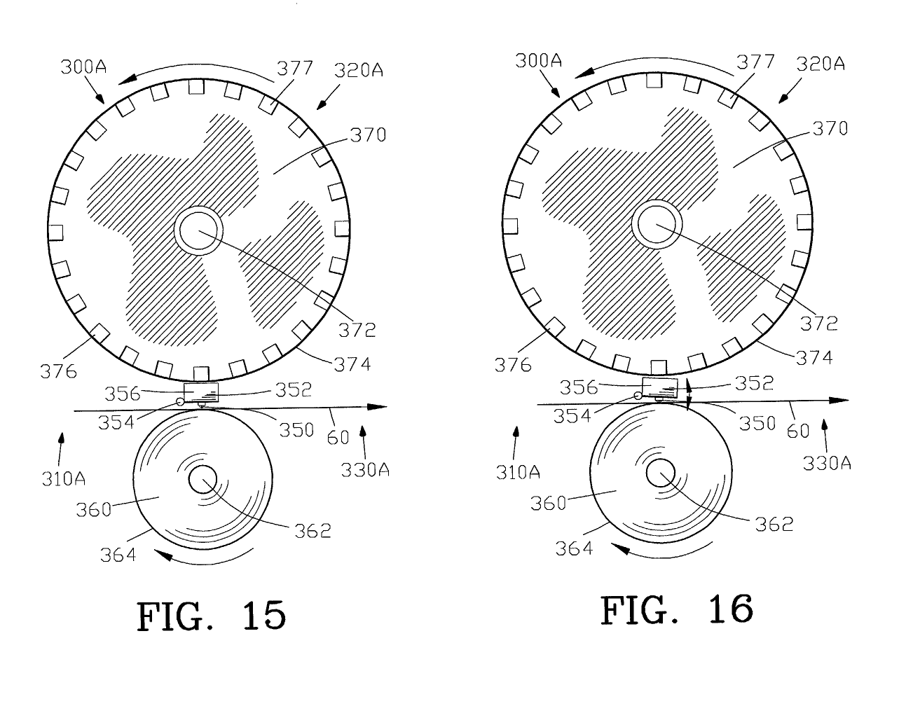

FIG. 10B is a block diagram of a second apparatus 300 for making intermittent bends in the array cladding 60. The second apparatus 300 comprises an array feeder 310 for feeding the array cladding 60 to a bender 320. In the second apparatus 300, the bender 320 is an intermittent bender 320 for intermittently bending the array cladding 60. The second apparatus 300 will be more fully explained with reference to FIGS. 15-24.

FIG. 11 is an isometric view of a first example 200A of the first apparatus 200 shown in FIG. 10A. The first example 200A of the first apparatus 200 performs the process step 15 of bending the array cladding 60 as shown in FIG. 1. The apparatus 220A comprises a plurality of rotatable members 241-245 being rotatable about a plurality of axes 251-255, respectively. The plurality of axes 251-255 are substantially parallel to one another. The plurality of rotatable members 241, 243 and 245 are located in an aligned row and offset from the plurality of rotatable members 242 and 244. The plurality of rotatable members 241-245 are freely rotatable about the plurality of axes 251-255.

The array cladding 60 is pulled from the array feeder 210A between the plurality of rotatable members 241-245 by the array receiver 230A. The free rotation of the plurality of rotatable members 241-245 forms sinusoidal bends 90 within the array clad being 60.

FIG. 12 is an isometric view of a second example 200B of the first apparatus 200 shown in FIG. 10A. The apparatus 200B performs the process step 15 of bending the array cladding 60 as shown in FIG. 1. The first apparatus 200 comprises a bushing 210B functioning as an array feeder 210B for feeding the array claddings 60 to the bender 220B. The bender 220B comprises a rotatable member 260 being rotatable about an axis 262. The axis 262 of the rotatable member 260 is disposed at generally parallel to the longitudinal extension of the array claddings 60 eminating from the array feeder 210B. The rotatable member 260 defines a guide aperture 264. The rotatable member 260 is driven by an external drive (not shown).

The array cladding 60 is pulled from the from the array feeder 210B through the guide aperture 264 defined in the rotatable member 260 by the array receiver 230B. The rotation of the rotatable member 260 forms continuous helical bends 90B within the array clad being 60. The array cladding 60 is freely movable within the guide aperture 264 to avoid twisting of the array cladding 60.

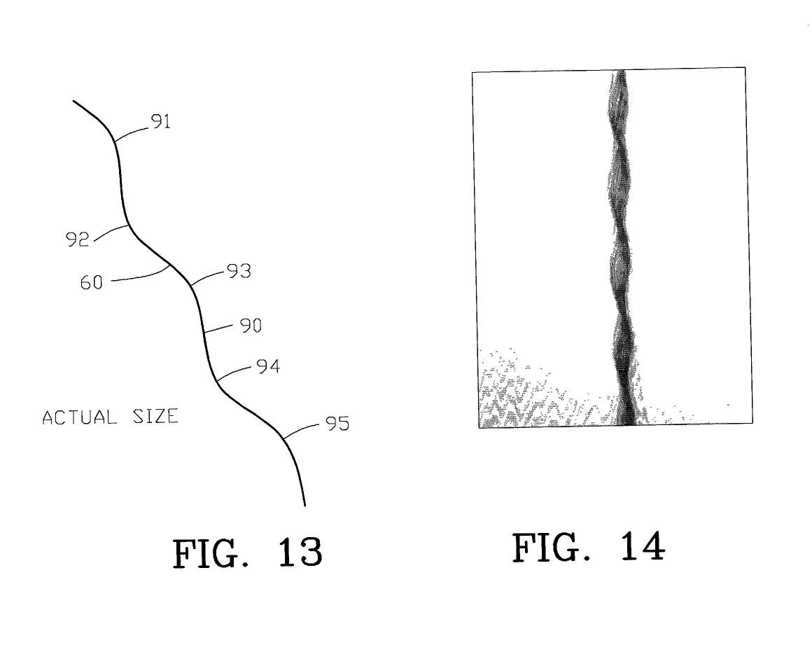

FIG. 13 is an elevational view of the actual size of the drawn second cladding 60 of FIG. 7. The drawn second cladding 60 was made of an array of approximately 3000 stainless steel wires 30 with each of the stainless steel wires 30 having a copper cladding 40. The array of the stainless steel wires 30 were clad with a carbon steel cladding material to form the second cladding 60. The second cladding 60 was drawn to a diameter of 0.03 inches. The drawn second cladding 60 was subjected to the bending process 15 to have a sinusoidal bend having a wavelength of 1.5 to 2.0 inches and an approximate amplitude of 0.125 inches.

FIG. 14 is a photograph of fine metallic fiber tow of FIG. 9 produced by the process of the present invention. The continuous fine metallic fiber tow 20 is of an extremely high quality. The continuous fine metallic fiber tow 20 had little memory of the bending after the removal of the wire cladding material 35 and the array cladding material 65.

FIG. 15 is a side elevational view of a first example 300A of the second apparatus 300 shown in FIG. 10B. The first example 300A of the second apparatus 300 performs the process step 15 of bending the array cladding 60 as shown in FIG. 1. The array cladding 60 is fed by the array feeder 310A to the intermittent bender 320A and is retrieved by the array receiver 330A.

The apparatus 300A comprises a hammer 350 and an anvil 360. The hammer 350 and anvil 360 are movable relative to one other for forming the intermittent bends in the array cladding 60. The array cladding 60 is passed between the hammer 350 and anvil 360 for forming the intermittent bends in the array cladding 60.

In this example, the hammer 350 is located on a hammer support 352 which is inevitably mounted by a pivot 354. The hammer support 352 includes a magnet 356 for pivotably moving the hammer support 352 on pivot 354 for reciprocating the hammer 350 relative to the anvil 360.

In this example, the anvil 360 comprises a resilient cylinder rotatably mounted on a shaft 362. The resilient cylinder 360 defines a peripheral surface 364. The resilient cylinder 360 is driven by an external drive (not shown).

A hammer driver cylinder 370 is rotatably mounted on a shaft 372. The hammer driver cylinder 370 defines a peripheral surface 374. A plurality of magnets 376 and 377 are disposed about the peripheral surface 374 of the hammer driver cylinder 370. A plurality of magnets 376 are interposed between the plurality of magnets 377 about peripheral surface 374 of the hammer driver cylinder 370. The plurality of magnets 376 are disposed in opposite polarity to the plurality of magnets 377. The hammer driver cylinder 374 is driven by an external drive (not shown) in unison with the resilient cylinder 360.

FIG. 16 is a view similar to FIG. 15 illustrating the intermittent bending of the array cladding 60. The rotation of the hammer driver cylinder 370 results in the plurality of magnets 376 and 377 of opposite polarity being passed in proximity to the magnet 356 of the hammer support 352. The attraction and repelling of the plurality of magnets 376 and 377 alternately pass in proximity to the magnet 356 of the hammer support 354 for pivotal reciprocating the hammer 350 against the anvil 360.

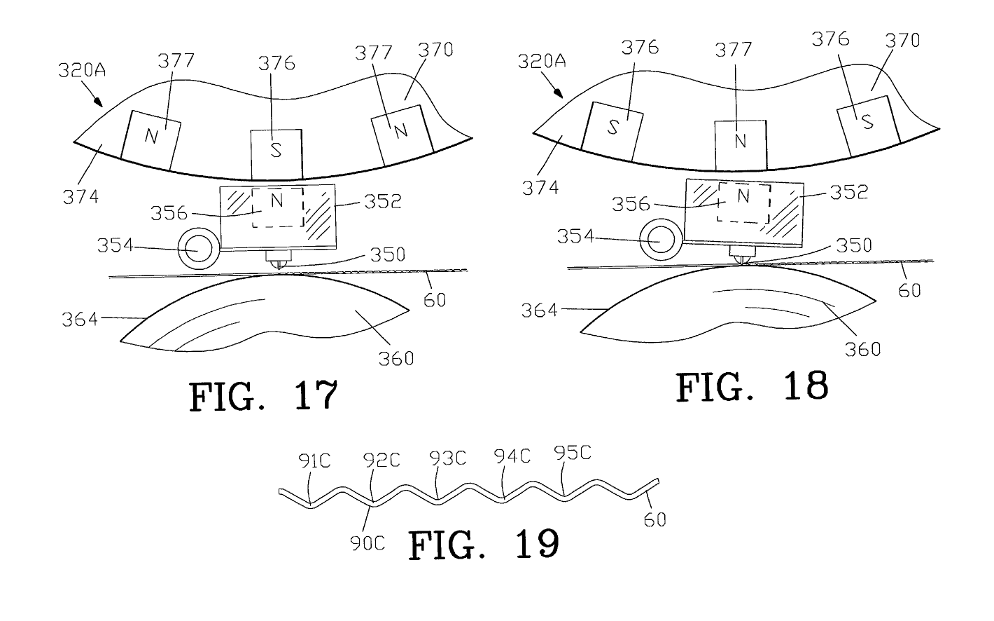

FIG. 17 is a magnified view of a portion of FIG. 15. The south pole of magnet 376 has been rotated to be adjacent to the north pole of magnet 356. The attraction between the magnets 356 and 376 upwardly rotates the hammer 350 about the pivot 354 in FIG. 17.

FIG. 18 is a magnified view of a portion of FIG. 16. The north pole of magnet 377 has been rotated to be adjacent to the north pole of magnet 356. The repulsion between the magnets 356 and 377 downwardly rotates the hammer 350 about the pivot 354 in FIG. 18.

The downward rotation in FIG. 18 of the hammer 350 about the pivot 354 cooperates with the anvil 360 to bend the array cladding 60. Preferably, the hammer 350 impacts the resilient anvil 360 to deform or bend the array cladding 60. The reciprocation of the hammer 350 results in an intermittent bending of the array cladding 60.

FIG. 19 is an elevational view of a bent array cladding 60 from the first example 300A of the second apparatus 300 shown 300 in FIGS. 15-18. The bent array cladding 60 includes a plurality of bends 91C-95C spaced along the bent array cladding 60. The spacing between each of the plurality of bends 91C-95C may be controlled by the speed of the array cladding 60 passing between the hammer 350 and the anvil 360 and/or the speed of reciprocal movement of the hammer 350. The depth of each of the plurality of bends 91C-95C may be controlled by the spacing between the hammer 350 and the anvil 360.

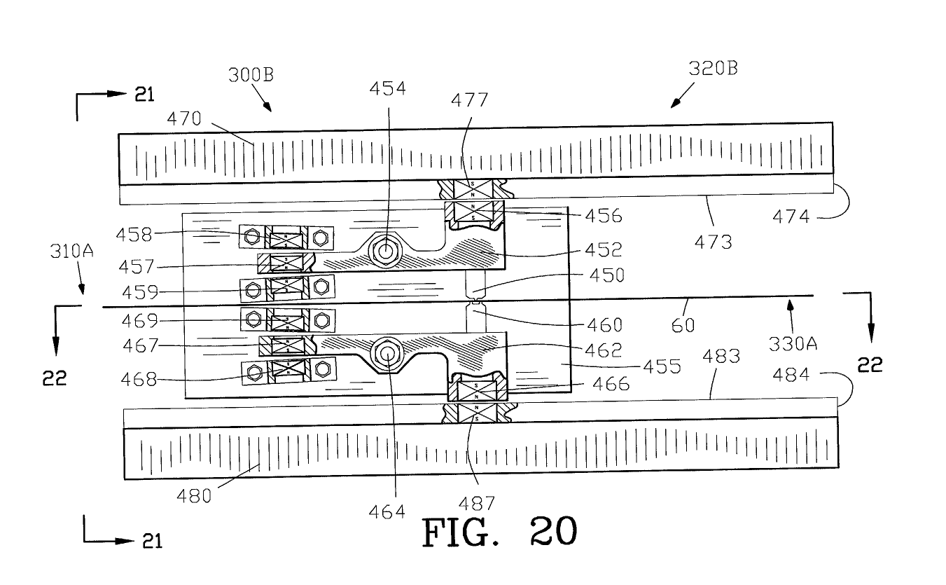

FIGS. 20-22 are various views of a second example 300B of the second apparatus 300 shown in FIG. 10B. The second example 300B of the second apparatus 300 performs the process step 15 of bending the array cladding 60 as shown in FIG. 1. The array cladding 60 is fed by the array feeder 310B to the intermittent bender 320B and is retrieved by the array receiver 330B.

The apparatus 300B comprises a hammer 450 and an anvil 460. The hammer 450 and anvil 460 are movable relative to one other for forming the intermittent bends in the array cladding 60. The array cladding 60 is passed between the hammer 450 and anvil 460 for forming the intermittent bends in the array cladding 60.

In this example, the hammer 450 is located on a hammer support 452 pivotably mounted by a pivot 454 to a bender frame 455. The hammer support 452 includes a magnet 456 for pivotably moving the hammer support 452 on pivot 454 for reciprocating the hammer 450 relative to the anvil 460.

The hammer support 452 includes a damping magnet 457 located between plural limiting magnets 458 and 459. The plural limiting magnets 458 and 459 are secured to the bender frame 455. Each of the plural limiting magnets 458 and 459 is oriented to repel the damping magnet 457 to bias the damping magnet 457 to be equidistant between the plural limiting magnets 458 and 459. The damping magnet 457 cooperates with the plural limiting magnets 458 and 459 to limit and/or to dampen the pivotable movement of the hammer support 452 on pivot 454.

In this example, the anvil 460 is located on an anvil support 462 pivotably mounted by a pivot 464 to the bender frame 455. The anvil support 462 includes a magnet 466 for pivotably moving the anvil support 462 on pivot 464 for reciprocating the anvil 460 relative to the hammer 450.

The anvil support 462 includes a damping magnet 467 located between plural limiting magnets 468 and 469. The plural limiting magnets 468 and 469 are secured to the bender frame 455. Each of the plural limiting magnets 468 and 469 is oriented to repel the damping magnet 467 to bias the damping magnet 467 to be equidistant between the plural limiting magnets 468 and 469. The damping magnet 467 cooperates with the plural limiting magnets 468 and 469 to limit and/or to dampen the pivotable movement of the anvil support 462 on pivot 464.

A hammer driver cylinder 470 is rotatably mounted on a shaft 472. The hammer driver cylinder 474 defines a side surface 473 and a peripheral surface 474. A plurality of magnets 476 and 477 are disposed in the side surface 473 in about the peripheral surface 474 of the hammer driver cylinder 470. A plurality of magnets 476 are interposed between the plurality of magnets 477 about peripheral surface 474 of the hammer driver cylinder 470. The plurality of magnets 476 are disposed in opposite polarity to the plurality of magnets 477. The hammer driver cylinder 474 is driven by an external drive (not shown) connected to the shaft 472.

An anvil driver cylinder 480 is rotatably mounted on the shaft 472. The anvil driver cylinder 484 defines a side surface 483 and a peripheral surface 484. A plurality of magnets 486 and 487 are disposed in the side surface 483 in about the peripheral surface 484 of the anvil driver cylinder 480. A plurality of magnets 486 are interposed between the plurality of magnets 487 about peripheral surface 484 of the anvil driver cylinder 480. The plurality of magnets 486 are disposed in opposite polarity to the plurality of magnets 487. The anvil driver cylinder 484 is driven in unison with the hammer driver cylinder 484 by the external drive (not shown) connected to the shaft 472.

The rotation of the hammer driver cylinder 470 alternately passes the plurality of magnets 476 and 477 of opposite polarity in proximity to the magnet 456 of the hammer support 454 for pivotal reciprocating the hammer 450. Simultaneously therewith, the rotation of the anvil driver cylinder 480 alternately passes the plurality of magnets 486 and 487 of opposite polarity in proximity to the magnet 466 of the anvil support 464 for pivotal reciprocating the anvil 460.

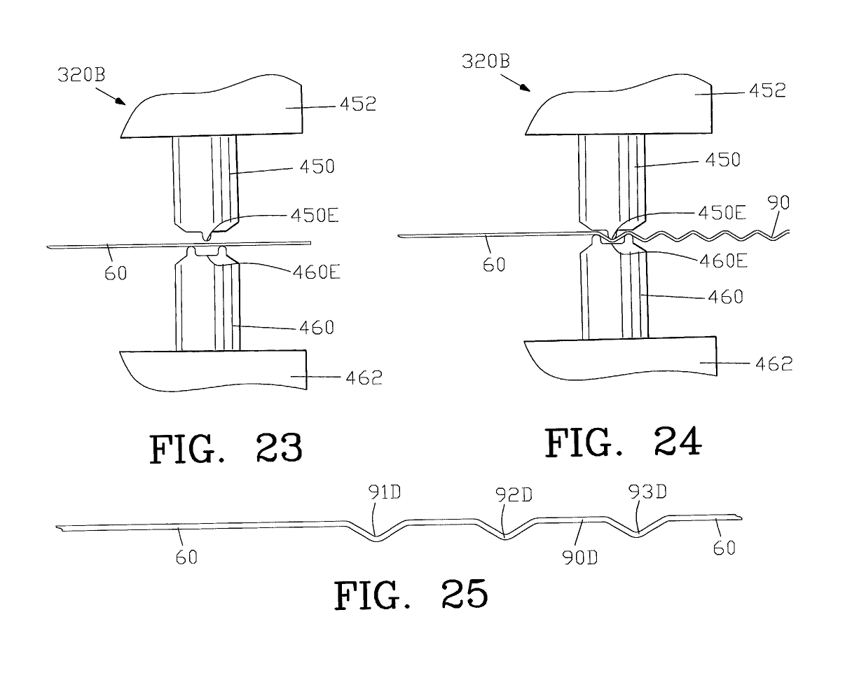

FIG. 23 is a magnified view of a portion of FIG. 20 illustrating the hammer 450 and the anvil 460 in an open position with the array cladding 60 located therebetween. In this example, the hammer 450 includes a contoured distal end 450E for cooperating with an anvil distal end 460E for forming a contoured bend 90 in the array cladding 60. The contoured distal ends 450E and 460E may take various forms and sizes for providing various shapes and sizes to the bend 90 in the array cladding 60.

FIG. 24 is a view similar to FIG. 23 illustrating the hammer 450 and the anvil 460 in a closed position for bending of the array cladding 60. The simultaneous pivoting of the hammer support 450 and the anvil 460 into the closed position enable the cooperating contoured distal ends 450E and 460E of the hammer 450 and the anvil 460 to form the contoured bend 90 in the array cladding 60.

The reciprocal movement of the hammer 450 and the anvil 460 form a series of the intermittent bends 90 in the array cladding 60. The frequency of the series of intermittent bands 90 may be controlled by the speed of the array cladding 60 passing between the hammer 450 and anvil 460 and/or the speed of reciprocal movement of the hammer 450 and the anvil 460. The contour, shape and size of each of the series of intermittent bands 90 in the array cladding 60 may be controlled by the spacing between the hammer 450 and the anvil 460 as well as the contour of the terminal ends 450E and 460E of the hammer 450 and the anvil 460.

FIG. 25 is an elevational view of a bent array cladding 90D from the second example of the second apparatus shown in FIGS. 20-24. The bent array cladding 90D includes a plurality of bends 91D-93D spaced intermittently along the bent array cladding 90D. The spacing between each of the plurality of bends 91D-93D may be controlled by the speed of the array cladding 60 passing between the hammer 450 and anvil 460 and/or the speed of reciprocal movement of the hammer 450 and the anvil 460. The depth each of the plurality of bends 91D-93D may be controlled by the spacing between the hammer 450 and the anvil 460 as well as the contour of the terminal ends 450E and 460E of the hammer 450 and the anvil 460.

The bending apparatus of the present invention as set forth herein may be used to provide a continuous or intermittent bend within the array cladding 60. In addition, the bending apparatus of the present invention may be used to provide intermittent crimps within the array cladding 60. When the bending apparatus is used to provide a continuous or intermittent bend within the array cladding 60, the fiber tow 85 exhibits little or no memory of the continuous or intermittent bends. In contrast, when the bending apparatus is used to provide intermittent crimps within the array cladding 60, the fiber tow 85 exhibits a memory of the intermittent crimps.

The foregoing has illustrated four apparatuses for forming bends or crimps within the array cladding 60. It should be appreciated by those skilled in the art that numerous other types of apparatuses may be incorporated for forming the bends or crimps within the array cladding. Although the process is not fully understood, it is believed that the process of the present invention provides the following four benefits.

Firstly, the bends or crimps located in one winding will not statistically align with the bends of an adjacent winding. The non-alignment of the bends or crimps of the adjacent windings minimizes the amount of contact between adjacent windings of the array cladding. The minimized amount of contact between adjacent windings of the array cladding reduces the likelihood of adjacent windings of the fine metallic fiber tow to become entangled. When adjacent windings of the fine metallic fiber tow to become entangled, many of the fine metallic fibers can be broken.

Secondly, the series of bends or crimps in the array cladding prevent the array cladding 60 from being tightly wound on the support. The reduction in the winding tension minimizes the amount of contact between adjacent windings of the array cladding. The reduction in the amount of contact between adjacent windings of the array cladding reduces the likelihood adjacent winding the fine metallic fiber tow to become entangled and/or producing broken fine metallic fibers.

Thirdly, the series of bends or crimps in the array cladding should be contrasted with a twist of the array cladding as utilized in the prior art. The process step 15 of bending set forth in the present invention produces fine metallic fiber tow in which the fine metallic fibers easily separate from one another.

Fourthly, the process step 15 of bending set forth in the present invention is not limited to small diameter cladding arrays. For example, it has been found that the maximum diameter for twisting arrays of the prior art is approximately 0.20 inches. The process step 15 of bending set forth in the present invention does not possess such limitations.

The present disclosure includes that contained in the appended claims as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

What is claimed is:

1. The process for making fine metallic fiber tow, comprising the steps of:
cladding an array of metallic wires with an array cladding material to provide an array cladding;
drawing the array cladding for reducing the diameter thereof and for reducing the corresponding diameters of each of the metallic wires of the array within the array cladding for producing an array of fine metallic fibers;
forming a series of bends along the longitudinal length of the array cladding;
placing the array cladding onto a support with the series of bends creating spaces between adjacent portions of the array cladding to minimize the number of direct contacts between adjacent portions of the array cladding; and
removing the array cladding material for producing metallic fiber tow.

2. The process for making fine metallic fiber tow as set forth in claim 1, wherein the step of cladding the array of metallic wires includes cladding a wire with a wire cladding material to provide a wire cladding;
assembling an array of the wire claddings; and
cladding the assembled array of wire claddings with the array cladding material to provide an array cladding.

3. The process for making fine metallic fiber tow as set forth in claim 1, wherein the step of
cladding the array of metallic wires includes electroplating a wire with a wire cladding material to provide a wire cladding;
assembling an array of the wire claddings; and
cladding the assembled array of wire claddings with the array cladding material to provide an array cladding.

4. The process for making fine metallic fiber tow as set forth in claim 1, wherein the step of drawing the array cladding includes a multiple drawing and annealing process for producing an array of fine metallic fibers.

5. The process for making fine metallic fiber tow as set forth in claim 1, wherein the step of placing the array cladding onto a support includes winding the array cladding onto a reel with the series of bends creating spaces between adjacent windings to minimize the number of direct contacts between the adjacent lateral windings of the array cladding.

6. The process for making fine metallic fiber tow as set forth in claim 1, wherein the step of placing the array cladding onto a support includes winding the array cladding onto a porous cylindrical reel with the series of bends creating spaces between adjacent windings to minimize the number of direct contacts between adjacent windings of the array cladding.

7. The process for making fine metallic fiber tow as set forth in claim 1, wherein the step of forming a series of bends in the array cladding includes forming a series of bends two dimension perpendicular to a third dimension extending along the longitudinal length of the array cladding.

8. The process for making fine metallic fiber tow as set forth in claim 1, wherein the step of forming a series of bends in the array cladding includes forming a continuous helical bend in the array cladding.

9. The process for making fine metallic fiber tow as set forth in claim 1, wherein the step of forming a series of bends in the array cladding includes forming a continuous sinusoidal bend in the array cladding.

10. The process for making fine metallic fiber tow as set forth in claim 1, wherein the step of removing the array cladding material includes chemically removing the array cladding material from the array of fine metallic fibers for producing fine metallic fiber tow.

11. The process for making fine metallic fiber tow, comprising the steps of:
cladding an array of metallic wires with an array cladding material to provide an array cladding;
drawing the array cladding for reducing the diameter thereof and for reducing the corresponding diameters of each of the metallic wires of the array within the array cladding for producing an array of fine metallic fibers;
forming a series of bends along the longitudinal length of the array cladding;
winding the array cladding onto a reel with the series of bends for spacing adjacent windings of the array cladding from one another on the reel for minimizing the direct contact between adjacent winding of the array cladding; and
removing the array cladding material for producing metallic fiber tow.

12. The process for making fine metallic fiber tow as set forth in claim 11, wherein the step of winding the array cladding onto a reel includes winding the array cladding onto a porous cylindrical reel with the series of bends creating spaces between adjacent windings to minimize the number of direct contacts between adjacent windings of the array cladding.

13. The process for making fine metallic fiber tow as set forth in claim 11, wherein the step of forming a series of bends in the array cladding includes forming a series of bends in two dimensions perpendicular to a third dimension extending along the longitudinal length of the array cladding.

14. The process for making fine metallic fiber tow as set forth in claim 11, wherein the step of forming a series of bends in the array cladding includes forming a continuous helical bend in the array cladding.

15. The process for making fine metallic fiber tow as set forth in claim 11, wherein the step of forming a series of bends in the array cladding includes forming a continuous sinusoidal bend in the array cladding.

16. The process for making fine metallic fiber tow as set forth in claim 11, wherein the step of forming a series of bends in the array cladding includes forming a continuous periodic series of curves in the array cladding.

17. An apparatus for bending a continuous wire, comprising
a feeder for feeding the continuous wire;
a bender for forming a bend in the continuous wire; and
a receiver for receiving the bent continuous wire from said bender.

18. An apparatus for bending a continuous wire as set forth in claim 17, wherein said bender forms a continuous bend within the continuous wire.

19. An apparatus for bending a continuous wire as set forth in claim 17, wherein said bender forms a series of intermittent bends along the continuous wire.

20. An apparatus for bending a continuous wire as set forth in claim 17, wherein said bender forms a series of bends in two dimensions perpendicular to a third dimension extending along the longitudinal length of the continuous wire.

21. An apparatus for bending a continuous wire as set forth in claim 17, wherein said bender forms a continuous helical bend in the continuous wire.

22. An apparatus for bending a continuous wire as set forth in claim 17, wherein said bender forms a continuous sinusoidal bend in the continuous wire.

23. An apparatus for bending a continuous wire as set forth in claim 17, wherein said bender forms a continuous periodic series of curves in the continuous wire.

24. An apparatus for bending a continuous wire, comprising
a feeder for feeding the continuous wire;
a bender comprising a plurality of rollers each having a roller axis;
said plurality of rollers being located with said roller axes being disposed in a substantial parallel relationship with adjacent rollers being offset from one another;
said plurality of rollers receiving the continuous wire between said adjacent rollers for forming a continuous bend in the continuous wire upon movement of the continuous wire through said plurality of rollers; and
a receiver for receiving the bent continuous wire from said plurality of rollers.

25. An apparatus for bending a continuous wire, comprising
a feeder for feeding the continuous wire;
a bender comprising a rotating bender having a bender rotational axis disposed substantially parallel to the continuous wire emanating from said feeder;
said bender having a bender guide located radially outward from said bender rotational axis;
said bender guide receiving the continuous wire for forming a continuous bend in the continuous wire upon rotation of said bender; and
a receiver for receiving the bent continuous wire from said bender.

26. An apparatus for bending a continuous wire, comprising
a feeder for feeding the continuous wire;
a bender comprising a hammer movably mounted relative to an anvil;
a bender guide receiving the continuous wire between said hammer and said anvil for forming a series of bends in the continuous wire upon movement of said hammer; and
a receiver for receiving the bent continuous wire from said bender.
